(19) United States
(12) Patent Application Publication
(10) Pub. No.: US 2016/0325214 A1
(43) Pub. Date: Nov. 10, 2016

(54) CONTAMINATE SEPARATOR FOR SEALS OF ROTATING SHAFTS

(71) Applicant: Caterpillar Inc., Peoria, IL (US)

(72) Inventor: Tyler John Davis, Washington, IL (US)

(73) Assignee: Caterpillar Inc., Peoria, IL (US)

(21) Appl. No.: 14/747,153

(22) Filed: Jun. 23, 2015

Related U.S. Application Data
(60) Provisional application No. 61/996,999, filed on May 6, 2015.

(51) Int. Cl. B01D 45/12; F16J 15/16; G06F 17/50; B29C 67/00

(52) U.S. Cl. CPC B01D 45/12; B29C 67/0088; F16J 15/16; G06F 17/5009; B33Y 10/00

(57) ABSTRACT

A contaminate separator for a seal of a rotatable shaft is provided. The contaminate separator may have an annular casing defining an internal cavity and being configured to rotate with the rotatable shaft. The annular casing may have an inlet port configured to direct air into the internal cavity. The annular casing may also have a first outlet passage configured to discharge a first air flow from the internal cavity to atmosphere. The annular casing may further have a second outlet passage configured to direct a second air flow from the internal cavity to the seal. The annular casing may be configured to separate particulates from the second air flow.

### RELATED APPLICATIONS

This application is entitled to and claims the benefit of priority from U.S. application Ser. No. 14/705,092 (Attorney Docket no. 08350.1873) by Davis, Tyler J., filed May 6, 2015, the contents of which are expressly incorporated herein by reference.

### TECHNICAL FIELD

The present disclosure relates generally to a contaminate separator, and more particularly, to a contaminate separator for seals of rotating shafts.

### BACKGROUND

Rotating shafts, such as crankshafts or drive shafts, often extend from a housing in which a lubricant, such as oil, is contained. A seal may be provided between the shaft and the housing to prevent leakage and/or contamination of the lubricant. Numerous types of seals (e.g., radial lip seals and end face mechanical seals) have been developed to provide a seal between rotating and stationary machine components. Radial shaft seals, for example, may have two main components including a rigid outer component designed to position and retain the seal in the housing, and a flexible inner lip designed to seal dynamically and statically against the shaft.

Seals utilized in rotating shaft applications may be exposed to contamination by particles naturally present in the ambient air. Such particles may degrade the seal over time, which may lead to high failure rates. For example, contaminates between the seal lip and the shaft may cause excessive heat generation due to the friction generated by the sliding contact. Excessive heat may accelerate aging of the lip material (e.g., a rubber material) and may lead to premature hardening and cracking of the seal lip. In addition, contaminates may abrade, wear, or create grooves in the seal lip and/or shaft, which may degrade the performance and cause leakage.

One attempt to reduce the amount of degradation caused by seal contamination is described in U.S. Pat. No. 4,114,902 (the '902 patent) issued to Orlowski on Sep. 19, 1978. The '902 patent describes sealing rings having a first ring and a second ring. The second ring is permitted to rotate within a recess of the first ring. Various grooves are formed between the rings designed to accumulate particles. The particles are expelled through an orifice in the first ring, where the particles will gravitate to due to the centrifugal action of the first ring rotating.

Although the sealing rings of the '902 patent may be capable of removing some particles that contaminate the seal, they may still suffer from a number of possible drawbacks. For example, the sealing rings of the '902 patent may only be able to remove particles that travel into the grooves of the rings. Therefore, the remaining portions of the seal may still be susceptible to contamination. In addition, the sealing rings of the '902 patent do not prevent particles from entering the seal, but rather, may only remove particles that are already in the seal. Consequently, the sealing rings may still be susceptible to contamination by the particles.

The separators and methods disclosed herein may be directed to mitigating or overcoming one or more of the possible drawbacks set forth above.

### SUMMARY

In one aspect, the present disclosure is directed to a contaminate separator for a seal of a rotatable shaft. The contaminate separator may include an annular casing defining an internal cavity and being configured to rotate with the rotatable shaft. The annular casing may include an inlet port configured to direct air into the internal cavity. The annular casing may also include a first outlet passage configured to discharge a first air flow from the internal cavity to atmosphere. The annular casing may further include a second outlet passage configured to direct a second air flow from the internal cavity to the seal. The annular casing may be configured to separate particulates from the second air flow.

In another aspect, a seal assembly for a rotatable shaft extending from a housing may include a seal mounted on the rotatable shaft and a contaminate separator mounted adjacent the seal. The contaminate separator may include an annular casing defining an internal cavity configured to rotate with the shaft. The annular casing may include an inlet port configured to direct air into the internal cavity. The annular casing may also include a first outlet passage configured to discharge a first air flow from the internal cavity. The annular casing may further include a second outlet passage configured to direct a second air flow from the internal cavity to the seal. The annular casing may be configured to separate particulates from the second air flow.

In yet another aspect, the present disclosure is directed to a method of protecting a seal mounted on a shaft from airborne contaminates. The method may include rotating a contaminate separator positioned adjacent the seal such that air is drawn into an internal cavity of the contaminate separator. The method may also include separating the air in the internal cavity into a higher-contaminated air flow and a lower-contaminated air flow. The method may further include discharging the higher-contaminated air flow from the internal cavity to the atmosphere. The method may also include directing the lower-contaminated air flow from the internal cavity to the seal

### BRIEF DESCRIPTION OF THE DRAWINGS

FIG. 1 is a partial section view of an exemplary embodiment of a seal assembly.

FIG. 2 is a perspective view of an exemplary embodiment of a contaminate separator.

FIG. 3 is a section view of the exemplary contaminate separator shown in FIG. 2.

FIG. 4 is section view along line 60 of FIG. 3.

FIG. 5 is a schematic drawing representing a system for generating a three-dimensional model of the contaminate separator.

### DETAILED DESCRIPTION

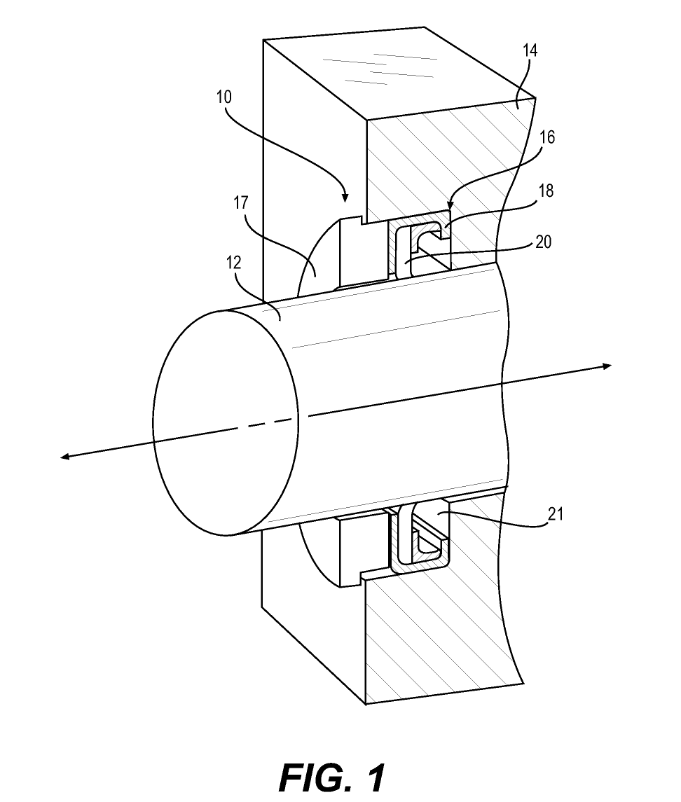

FIG. 1 illustrates an exemplary embodiment of a seal assembly 10 for use in fluidly sealing a rotatable shaft 12 mounted within a housing 14. Shaft 12 may be, for example, a driveshaft, a crankshaft, a propeller shaft, or another type of rotating shaft that extends from housing 14. Housing 14 may be, for example, an engine block, a gear box, a joint, or another mechanical component. Housing 14 may contain a lubricant, such as oil. To prevent leakage or contamination of the lubricant in housing 14, an exemplary seal assembly 10 may be annularly located between shaft 12 and housing 14.

Exemplary seal assembly 10 may include, for example, a seal 16 and a contaminate separator 17 positioned adjacent seal 16. Although exemplary seal 16 is shown in FIG. 1 in the form of a lip seal, seal 16 may be any type of suitable rotary seal and may vary in configuration (e.g., the construction, materials, size, etc., may vary).

According to the exemplary embodiment shown in FIG. 1, lip seal 16 may have, for example, a rigid outer component 18 and a flexible inner lip 20. Outer component 18 may be configured to position and retain seal 16 in housing 14. Outer component 18 may be formed from a range of materials, for example, carbon steel, aluminum, stainless steel, a non-metallic composite, or any other materials having similar characteristics. Outer component 18 may be configured to create a substantial leak-free fit between seal 16 and housing 14. For example, an outside diameter of outer component 18 may be slightly larger than a bore 21 of housing 14, thereby creating a fixed leak-free press fit. The actual seal diameter may vary depending on, for example, the size and/or material of housing 14, internal pressure, and/or temperature.

Inner lip 20 may be coupled to outer component 18 via, for example, bonding or mechanically crimping Inner lip 20 may be configured to contact shaft 12 around its outer circumference and provide both a static and dynamic seal Inner lip 20 may be configured as a retention lip (e.g., as shown in FIG. 1), the primary purpose of which may be to retain lubricant within housing 14. According to some embodiments, inner lip 20 may be an excluder lip, the primary purpose of which may be to exclude contaminates from entering housing 14. Some embodiments of seal 16 may include multiple lips including retention and/or excluder lips, for example. The configuration of inner lip 20 may vary based on, for example, the type of application, speed, temperature, and/or pressure associated with the shaft 12. According to some embodiments, inner lip 20 may be springless or spring-loaded Inner lip 20 may be formed from a range of materials, such as, for example, polytetrafluoroethylene (PTFE), nitrile (NBR), fluoroelastomer (FKM), ethylene propylene (EPDM), polyacrylate (ACM), Silicone (VMQ), and/or Neoprene (CR).

As shown in FIG. 1, exemplary seal 16 may be positioned in bore 21 formed in housing 14. Although seal 16 in FIG. 1 is shown recessed into bore 21, in some embodiments, the outer surface of seal 16 may be flush with the outer surface of housing 14. In some embodiments, a portion of seal 16 may extend out from housing 14. The configuration of housing 14 and bore 21 may vary based on the type of housing. For such embodiments, separator 17 may be positioned adjacent seal 16 on shaft 12. The separation between separator 17 and seal 16 may vary, for example, from about zero inches to about one inch or more. As shown in FIG. 1, when exemplary seal 16 is recessed in bore 21, exemplary separator 17 may also be at least partially recessed within bore 21. In some embodiments, separator 17 may be fully recessed in bore 21 or may be fully external to bore 21.

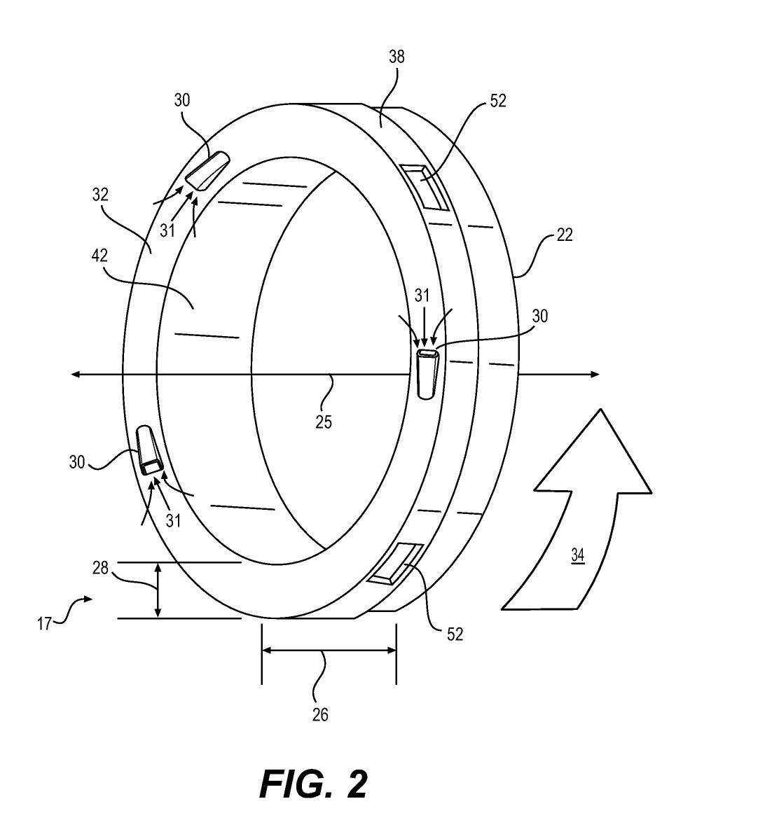

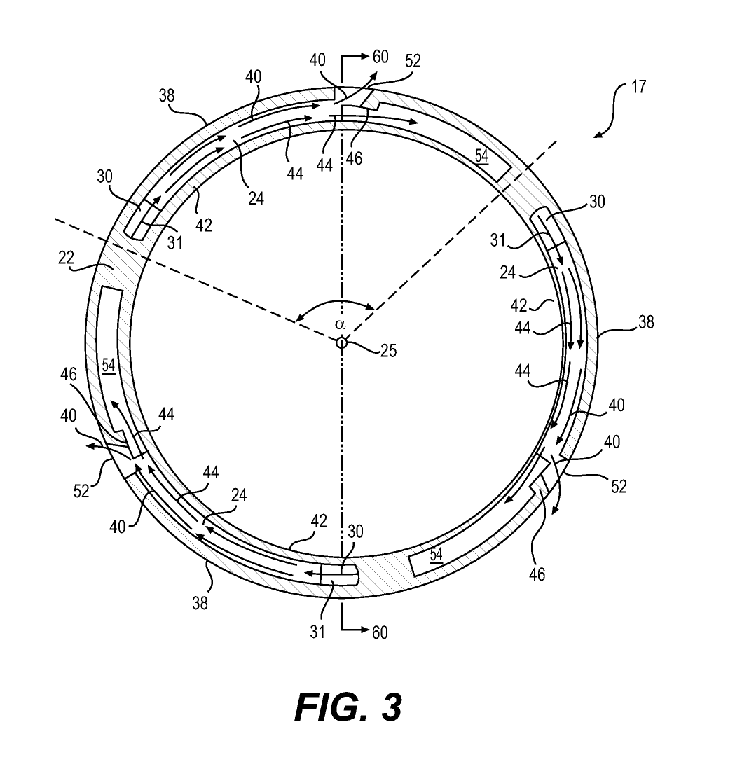

FIGS. 2 and 3 show exemplary separator 17 having an annular casing 22 that defines one or more annularly shaped internal cavities 24. The cross-sectional shape of casing 22 along an axis 25 may be generally rectangular, or in some embodiments, the cross-sectional shape may be circular, elliptical, trapezoidal, or other shapes. A cross-section of annular casing 22 may have an axial length 26 and a radial thickness 28 that vary depending on the configuration and/or use of corresponding shaft 12, seal 16, and/or bore 21. Radial thickness 28 may vary along axial length 26. For example, in the exemplary embodiments shown in FIGS. 1 and 2, there is a step change in the radial thickness of casing 22 along axial length 26. The step change in the radial thickness may be configured to correspond to the depth to which separator 17 may extend into bore 21, for example, as shown in FIG. 1. In some embodiments, radial thickness 28 may increase or decrease gradually along axial length 26.

Casing 22 may be formed of one or more components. For example, casing 22 may be formed of two separate annular rings that are configured to be coupled together. For example, according to some embodiments, casing 22 may be formed from two ring-shaped halves that are configured to be coupled around shaft 12. Such an exemplary assembly may simplify installation of separator 17, for example, by eliminating the need to slip separator 17 over the end of shaft 12. The two components may be coupled to each other using a variety of techniques, such as, for example, bonding and/or mechanical fastening.

Axial length 26 and radial thickness 28 of casing 22 may vary depending on, for example, the use and/or the size of the corresponding shaft 12, seal 16, and bore 21. For example, in some embodiments where separator 17 is at least partially recessed within bore 21, radial thickness 28 of at least a portion of casing 22 may be selected to ensure adequate clearance between an outer diameter of separator 17 and an inner surface of bore 21. In some embodiments where a portion of separator 17 is external to bore 21, that external portion may have a greater radial thickness 28 than the portion internal to bore 21, for example, as shown in FIG. 1. In some embodiments where separator 17 is entirely external to housing 14, axial length 26 and radial thickness 28 may be more freely varied because the available space is not limited by bore 21. The selection of axial length 26 and radial thickness 28 may also vary based on other considerations, such as, for example, the ambient atmospheric air quality of an application. For example, in applications where the ambient air has larger and/or a greater concentration of particles, the cross-section of casing 22 may have a greater axial length 26 and/or radial thickness 28.

According to some embodiments, casing 22 may be configured to be coupled to shaft 12, for example, such that separator 17 may rotate together with shaft 12. Casing 22 may be coupled to shaft 12 by any suitable means, for example, a mechanical interference fit. In some embodiments, for example, where a component of seal 16 rotates with shaft 12 (e.g., for end face mechanical seals), casing 22 may be coupled to the rotating component of seal 16, such that both casing 22 and the rotating seal component rotate with shaft 12. Casing 22 may be coupled to the rotating component of seal 16 by a variety of techniques, such as, for example, adhesive bonding and/or mechanical fastening. In some embodiments, for example, where a component of seal 16 rotates with shaft 12, casing 22 may be formed as an integral component of the seal. For example, the rotating portion of seal 16 may extend out from housing 14 and encompass separator 17.

Casing 22 may be formed from a variety of materials that have suitable material properties. For example, casing 22 may be formed from metal (e.g., aluminum, cast iron, stainless steel, or other alloys), a polymer (e.g., CR, EPDM, PTFE, NBR, or other polymer), a composite (e.g., fiber glass, carbon fiber, reinforced plastics, or other composite), and/or any other materials having similar characteristics. In some embodiments, casing 22 may be formed from a combination of materials, for example, a metal or composite frame encased in a polymer. In some embodiments, casing 22 may be produced by an additive material manufacturing process, for example, 3D printing. The material selection may vary based on the parameters of the application, for example, temperature, rotational speed, pressure, and/or corrosiveness of the environment. A selected material may be sufficiently rigid such that it maintains shape at high rotational speeds.

According to some embodiments, separator 17 may further include one or more inlet ports 30 configured to draw ambient air 31 into the internal cavities 24, for example, as shown in FIGS. 2-4. Inlet ports 30 may be positioned on an outer axial end wall 32 of casing 22 opposite seal 16. In some embodiments, for example as shown in FIGS. 2 and 3, separator 17 includes three inlet ports 30 spaced substantially evenly around outer axial end wall 32. In some embodiments, separator 17 may include less than or more than three inlet ports 30. The number of inlet ports may correspond with the number of internal cavities so they are equal, for example. Inlet ports 30 may define, for example, a ramped surface forming a hood-shaped projection that extends axially outward from the surface of outer axial end wall 32.

According to some embodiments, the projection of inlet ports 30 may be oriented toward a direction of rotation 34 of shaft 12 and separator 17. As shaft 12 and separator 17 rotate, ambient air 31 can be induced or directed (i.e., pushed, scooped, or funneled) into the openings of inlet ports 30 and internal cavities 24, for example, as shown in FIG. 2. In applications where shaft 12 rotates in both directions (e.g., a drive shaft), the orientation of inlet ports 30 may be based on a predominate direction of rotation, or different inlet ports 30 may face in different directions.

In some embodiments, inlet ports 30 may be configured such that the orientation of the opening switches based on the direction of rotation of shaft 12. In some embodiments, one or more of inlet ports 30 may be generally flush with the surface of outer axial end wall 32, whereby the rotation of separator 17 draws the ambient air into internal cavities 24. In some embodiments, inlet ports 30 may be positioned on other surfaces of casing 22, for example, an outer annular wall 38.

In the exemplary embodiment shown in FIG. 3, casing 22 has plurality (e.g., three) internal cavities 24, and each internal cavity 24 extends only partially around the circumference of casing 22. For example, internal cavities 24 may extend through an angle α. Angle α may range from, for example, about 90 degrees to about 180 degrees. The number of internal cavities 24 may determine the maximum angle α through which they extend. For example, three internal cavities 24 may each extend up to about 120 degrees, four internal cavities 24 may each extend up to about 90 degrees, and two internal cavities 24 may each extend up to about 180 degrees. In some embodiments, casing 22 may have a single internal cavity, which may extend up to 360 degrees.

As shown in FIG. 3, exemplary separator 17 may be configured such that air 31 directed into separator 17 may circulate within internal cavities 24 as separator 17 rotates with shaft 12. As air 31 begins to circulate within internal cavities 24, centrifugal forces will be applied to contaminates (e.g., dust and dirt particles) present in air 31, thereby accelerating the particles perpendicular to the axis of circulation. Larger, heavier, and denser particles will move outward in a radial direction and accumulate at an inner surface of outer annular wall 38 of internal cavities 24, thereby forming circulating air flows 40 (i.e., first air flows) having a relatively higher concentration of particles. The movement of the larger, heavier, and denser particles outward will displace smaller, lighter, and less dense particles, thereby causing them to move inward and accumulate at an inner surface of inner annular wall 42 of internal cavities 24, thereby forming circulating air flows 44 (i.e., second air flows) having a lower concentration of particles.

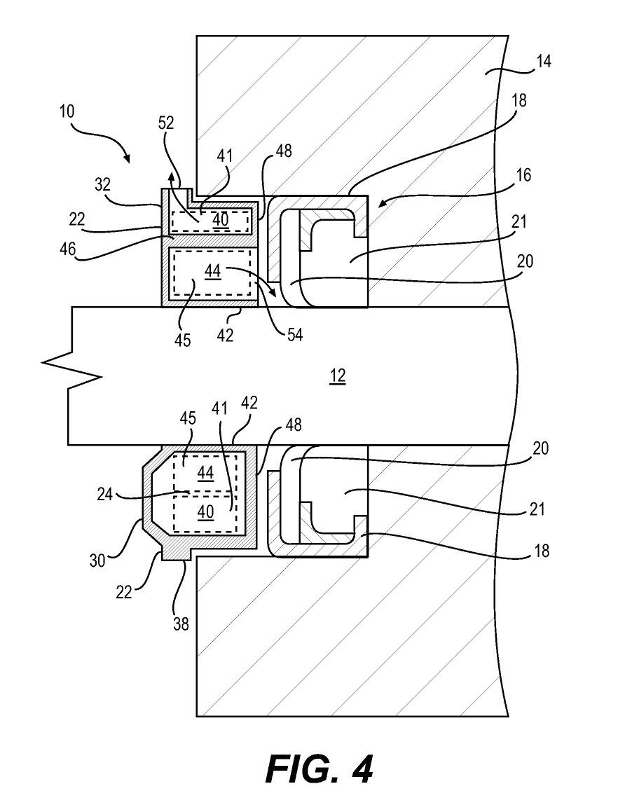

As shown in FIG. 4, exemplary air flows 40 and air flows 44 may circulate in internal cavities 24 forming radial layers (e.g., outer radial layer 41 and inner radial layer 45 shown in dashed lines for clarity), respectively. Air flows 44 circulating within inner radial layer 45 may generally contain a lower concentration of larger, heavier, and denser particles than air 31 directed into internal cavities 24 through inlet ports 30. The larger, heavier, and denser particles generally absent from air flows 44 or at a reduced concentration may be typically the particles that create the most problems for seal 16 by causing wear and degradation of inner lip 20.

As shown in FIGS. 3 and 4, exemplary casing 22 may include geometries within internal cavities 24 configured to aid in separating air flows 40 from air flows 44, and/or to physically divide a portion of internal cavities 24 in outer radial layer 41 and inner radial layer 45. For example, as shown in FIGS. 3 and 4, exemplary casing 22 may include diverters 46 disposed within each internal cavity 24 at an end generally downstream of where air 31 enters the corresponding internal cavity 24. In some embodiments, diverters 46 may be formed as part of casing 22 and extend from outer axial end wall 32 to inner axial end wall 48. In some embodiments, diverters 46 may extend only a portion of the axial distance between outer axial end wall 32 and inner axial end wall 48. A leading edge of diverters 46 may be positioned radially about midway between outer annular wall 38 and inner annular wall 42, thereby physically separating the corresponding internal cavity 24 into outer radial layer 41 and inner radial layer 45. In some embodiments, the positioning of diverters 46 may be different. For example, diverters 46 may be positioned closer to outer annular wall 38 or closer to inner annular wall 42. In some embodiments, diverters 46 may extend circumferentially upstream along internal cavities 24. In some embodiments, the selection of separator 17 having a particular positioning for diverter 46 may be based on various factors, such as, for example, the seal type, the seal application, and/or the ambient air quality.

Exemplary separator 17 may further include one or more first outlet passages 52 and one or more second outlet passages 54 defined by casing 22, that are in flow communication with internal cavities 24. Each internal cavity 24 may have a first outlet passage 52 and a second outlet passage 54. In some embodiments, for example, the number of first outlet passages 52 and second outlet passages 54 may correspond to (e.g., may be equal) the number of internal cavities 24. In the exemplary embodiment shown in FIG. 4, first outlet passages 52 may be configured to discharge air flows 40 from outer radial layer 41 of the corresponding internal cavity 24, while second outlet passages 54 may be configured to discharge air flows 44 from inner radial layer 45 of the corresponding internal cavity 24.

In the exemplary embodiment shown in FIGS. 2-4, first outlet passages 52 are positioned on outer annular wall 38. In some embodiments, first outlet passages 52 may be positioned on outer axial end wall 32. In the exemplary embodiment shown in FIGS. 3 and 4, second outlet passages 54 are positioned on inner axial end wall 48. In some embodiments, second outlet passages 54 may be positioned on outer annular wall 38. For embodiments where both first outlet passages 52 and second outlet passages 54 are positioned on outer annular wall 38, they may be positioned, for example, next to one another in pairs or positioned in staggered pairs. As shown in FIGS. 3 and 4, exemplary first outlet passages 52 and second outlet passages 54 may be flush with the surface of the corresponding wall in which they are disposed.

As shown in FIGS. 3 and 4, exemplary diverters 46 may be positioned between first outlet passages 52 and second outlet passages 54 to separate air flows 40 and 44 for discharge from internal cavities 24. In the exemplary embodiment shown in FIG. 3, each diverter 46 may include a ramp or inclined surface that extends from the leading edge to the corresponding first outlet passage 52 configured to redirect air flow 40 out of first outlet passage 52. As shown in FIG. 3, exemplary second outlet passages 54 may extend circumferentially from the corresponding diverter 46 to the next inlet port 30. Second outlet passages 54 may be any suitable shape for discharging air flows 44 from inner axial end wall 48. In some embodiments, for example, second outlet passages 54 may include a curved or sloped surface configured to redirect the circumferential flow of air flows 44 out from inner axial end wall 48.

In some embodiments, first outlet passages 52 and second outlet passages 54 may include ramped surfaces forming hood-shaped projections that extend radially outward from the wall on which they are disposed. The hood-shaped projections may have openings that face, for example, away from and/or perpendicular to the direction of rotation 34. For example, in some embodiments, first outlet passages 52 may face away from the direction of rotation 34, while second outlet passages 54 face perpendicular to the direction of rotation toward seal 16. In some embodiments, first outlet passages 52 may be configured to discharge air flows 40 directly to the atmosphere (i.e., ambient environment). For example, as shown in FIG. 4, exemplary first outlet passages 52 may be positioned exterior to bore 21. In some embodiments where first outlet passages 52 are positioned interior with respect to bore 21, a conduit, duct, passage, and/or other suitable means of fluid communication may be used to direct air flows 40 from first outlet passages 52 to the atmosphere.

According to some embodiments, second outlet passages 54 may be configured to direct air flows 44 into bore 21. For example, as shown in FIG. 4, second outlet passages 54 may be positioned within bore 21 and configured to direct air flow 44 directly at inner lip 20 of seal 16.

### INDUSTRIAL APPLICABILITY

The contaminate separator of the present disclosure may be applicable to any rotary seal where increased reliability and longer life are desired. The disclosed contaminate separator may increase reliability and extend seal life by reducing an amount of contaminates (e.g., particles) in contact with the seal. Operation of contaminate separator 17 will now be discussed in detail.

According to some embodiments, during rotational operation of shaft 12, separator 17 may rotate with shaft 12 and, in some embodiments (e.g., a mechanical face seal), with a rotating component of the seal. While rotating with shaft 12, separator 17 may draw ambient air into internal cavities 24 through inlet ports 30. The ambient air flowing into internal cavities 24 may contain contaminates, for example, particles or particulates of varying size. Due to the rotation of separator 17 and the air inside internal cavities 24, a centrifugal force may be applied to the particles that cause the larger, heavier, and denser particles to move outward, while the smaller, lighter, less dense particles are displaced and move inward. Consequently, the air in internal cavities 24 may be separated into higher-contaminated air flows 40 (e.g., dirtier air flow) and lower-contaminated air flows 44 (e.g., cleaner air flow).

Air flows 40 and air flows 44 may be separated by diverters 46 and discharged from internal cavities 24 by way of first outlet passages 52 and second outlet passages 54, respectively. In some embodiments, first outlet passages 52 may be positioned external to bore 21, thereby enabling air flows 40 to be discharged directly into the atmosphere. In such embodiments, second outlet passages 54 may be positioned within bore 21, thereby enabling air flows 44 to be directed into bore 21. More specifically, air flows 44 may be directed, for example, to inner lip 20 of seal 16.

Air flows 44, being directed into bore 21, may generate a positive pressure (i.e., pressure greater than the surrounding environment) within bore 21. The positive pressure may cause air to flow out of bore 21, thereby inhibiting ingress of ambient air, which may contain larger contaminates (e.g., dust and dirt particles) into bore 21 (e.g., between outer annular wall 38 and the inner surface of bore 21). By inhibiting introduction of ambient air into bore 21, large particles entrained in the ambient air may be inhibited from entering bore 21 and contacting seal 16 at, for example, inner lip 20. The positive pressure difference may range, for example, from greater than about 0 psi to about 3 psi.

Although, the embodiments of contaminate separator 17 disclosed herein have been described in relation to seals that contact a radial surface of the shaft, the use of contaminate separator 17 is not so limited. Contaminate separator 17 may also be used in conjunction with seals configured to contact and seal an axial surface (e.g., an axial end wall) of a rotating shaft.

The disclosed contaminate separator 17 may be manufactured using conventional techniques such as, for example, casting or molding. Alternatively, the disclosed contaminate separator 17 may be manufactured using conventional techniques generally referred to as additive manufacturing or additive fabrication. Known additive manufacturing/fabrication processes include techniques such as, for example, 3D printing. 3D printing is a process wherein material may be deposited in successive layers under the control of a computer. The computer controls additive fabrication equipment to deposit the successive layers according to a three-dimensional model (e.g. a digital file such as an AMF or STL file) that is configured to be converted into a plurality of slices, for example substantially two-dimensional slices, that each define a cross-sectional layer of the contaminate separator 17 in order to manufacture, or fabricate, the contaminate separator. In one case, the disclosed contaminate separator would be an original component and the 3D printing process would be utilized to manufacture the contaminate separator. In other cases, the 3D process could be used to replicate an existing contaminate separator and the replicated contaminate separators could be sold as aftermarket parts. These replicated aftermarket contaminate separators could be either exact copies of the original contaminate separators or pseudo copies differing in only non-critical aspects.

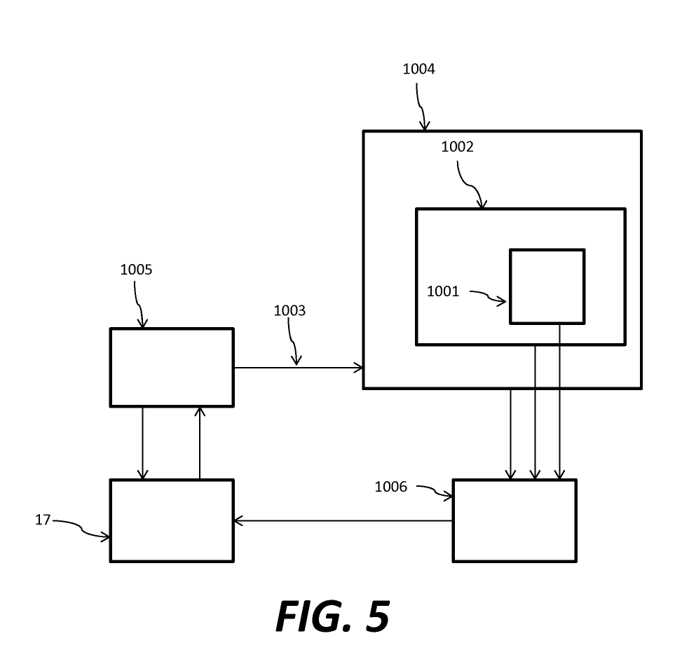

With reference to FIG. 5, the three-dimensional model 1001 used to represent an original contaminate separators may be on a computer-readable storage medium 1002 such as, for example, magnetic storage including floppy disk, hard disk, or magnetic tape; semiconductor storage such as solid state disk (SSD) or flash memory; optical disc storage; magneto-optical disc storage; or any other type of physical memory on which information or data readable by at least one processor may be stored. This storage medium may be used in connection with commercially available 3D printers 1006 to manufacture, or fabricate, the contaminate separators. Alternatively, the three-dimensional model may be transmitted electronically to the 3D printer 1006 in a streaming fashion without being permanently stored at the location of the 3D printer 1006. In either case, the three-dimensional model constitutes a digital representation of the contaminate separators suitable for use in manufacturing the contaminate separators.

The three-dimensional model may be formed in a number of known ways. In general, the three-dimensional model is created by inputting data 1003 representing the contaminate separator to a computer or a processor 1004 such as a cloud-based software operating system. The data may then be used as a three-dimensional model representing the physical contaminate separator. The three-dimensional model is intended to be suitable for the purposes of manufacturing the contaminate separator. In an exemplary embodiment, the three-dimensional model is suitable for the purpose of manufacturing the contaminate separator by an additive manufacturing technique.

In one embodiment depicted in FIG. 5, the inputting of data may be achieved with a 3D scanner 1005. The method may involve contacting the contaminate separator 17 via a contacting and data receiving device and receiving data from the contacting in order to generate the three-dimensional model. For example, 3D scanner 1005 may be a contact-type scanner. The scanned data may be imported into a 3D modeling software program to prepare a digital data set. In one embodiment, the contacting may occur via direct physical contact using a coordinate measuring machine that measures the physical structure of the contaminate separator by contacting a probe with the surfaces of the contaminate separator in order to generate a three-dimensional model. In other embodiments, the 3D scanner 1005 may be a non-contact type scanner and the method may include directing projected energy (e.g. light or ultrasonic) onto the contaminate separator to be replicated and receiving the reflected energy. From this reflected energy, a computer would generate a computer-readable three-dimensional model for use in manufacturing the contaminate separator. In various embodiments, multiple 2D images can be used to create a three-dimensional model. For example, 2D slices of a 3D object can be combined to create the three-dimensional model. In lieu of a 3D scanner, the inputting of data may be done using computer-aided design (CAD) software. In this case, the three-dimensional model may be formed by generating a virtual 3D model of the disclosed contaminate separator using the CAD software. A three-dimensional model would be generated from the CAD virtual 3D model in order to manufacture the contaminate separator.

The additive manufacturing process utilized to create the disclosed contaminate separator 17 may involve materials such as plastic, rubber, metal, etc. In some embodiments, additional processes may be performed to create a finished product. Such additional processes may include, for example, one or more of cleaning, hardening, heat treatment, material removal, and polishing. Other processes necessary to complete a finished product may be performed in addition to or in lieu of these identified processes.

It will be apparent to those skilled in the art that various modifications and variations can be made to the contaminate separator of the present disclosure without departing from the scope of the disclosure. Other embodiments will be apparent to those skilled in the art from consideration of the specification and practice of the disclosed contaminate separator. It is intended that the specification and examples be considered as exemplary only, with a true scope being indicated by the following claims and their equivalents.

What is claimed is:

1. A contaminate separator for a seal of a rotatable shaft, the contaminate separator comprising:
an annular casing defining an internal cavity and being configured to rotate with the rotatable shaft, the annular casing including:
an inlet port configured to direct air into the internal cavity;
a first outlet passage configured to discharge a first air flow from the internal cavity to atmosphere; and
a second outlet passage configured to direct a second air flow from the internal cavity to the seal,
wherein the annular casing is configured to separate particulates from the second air flow.

2. The contaminate separator of claim 1, wherein the casing is configured to separate the particulates from the second air flow such that the first air flow contains a higher concentration of particle contaminates than the second air flow.

3. The contaminate separator of claim 1, wherein the casing is configured to separate the particulates from the second air flow such that the second air flow contains a lower concentration of particle contaminates than the air directed into the internal cavity.

4. The contaminate separator of claim 1, wherein the casing defines a diverter configured to separate the internal cavity into radial layers, each having a different concentration of contaminates.

5. The contaminate separator of claim 1, wherein the casing includes a plurality of the internal cavities, a plurality of the inlet ports, a plurality of the first outlet passages, and a plurality of the second outlet passages, and wherein the casing includes the same number of each of the plurality of the internal cavities, the plurality of the inlet ports, the plurality of the first outlet passages, and the plurality of the second outlet passages.

6. The contaminate separator of claim 1, wherein:
the annular casing includes an inner axial end wall opposite an outer axial end wall;
the inner axial end wall and the outer axial end wall are coupled to one another by an inner annular wall and an outer annular wall;
the inlet port is positioned on the outer axial end wall; and
the first and second outlet ports are positioned on the outer annular wall.

7. The contaminate separator of claim 1, wherein:
the annular casing has an inner axial end wall opposite an outer axial end wall;
the inner axial end wall and the outer axial end wall are coupled to one another by an inner annular wall and an outer annular wall;
the inlet port is positioned on the outer axial end wall; and
the first outlet passage is positioned on the outer annular wall, and the second outlet passage is positioned on the inner axial end wall.

8. A seal assembly for a rotatable shaft extending from a housing, comprising:
a seal mounted on the rotatable shaft; and
a contaminate separator mounted adjacent the seal, the contaminate separator including:
an annular casing defining an internal cavity configured to rotate with the shaft, the annular casing including:
an inlet port configured to direct air into the internal cavity;
a first outlet passage configured to discharge a first air flow from the internal cavity; and
a second outlet passage configured to direct a second air flow from the internal cavity to the seal,
wherein the annular casing is configured to separate particulates from the second air flow.

9. The seal assembly of claim 8, wherein the casing is configured to separate the particulates from the second air flow such that the first air flow contains a higher concentration of particle contaminates than the second air flow.

10. The seal assembly of claim 8, wherein the casing is configured to separate the particulates from the second air flow such that the second air flow contains a lower concentration of particle contaminates than the air directed into the internal cavity.

11. The seal assembly of claim 8, wherein the seal is configured to mount within a bore of the housing, and the separator is positioned partially within the bore such that the first outlet passage discharges the first air flow external to the bore and the second outlet passage directs the second air flow into the bore, which houses the seal.

12. The seal assembly of claim 11, wherein the air flow directed to the seal is configured to create a positive pressure within the bore.

13. The seal assembly of claim 8, wherein the casing defines a diverter configured to separate the internal cavity into radial layers, each having a different concentration of contaminates.

14. The seal assembly of claim 8, wherein the casing includes a plurality of the internal cavities, a plurality of the inlet ports, a plurality of the first outlet passages, and a plurality of the second outlet passages, and wherein the casing includes the same number of each of the plurality of the internal cavities, the plurality of the inlet ports, the plurality of the first outlet passages, and the plurality of the second outlet passages.

15. The seal assembly of claim 8, wherein:
the annular casing has an inner axial end wall opposite an outer axial end wall;
the inner axial end wall and the outer axial end wall are coupled to one another by an inner annular wall and an outer annular wall;
the inlet port is positioned on the outer axial end wall; and
the first and second outlet ports are positioned on the outer annular wall.

16. The seal assembly of claim 8, wherein:
the annular casing has an inner axial end wall opposite an outer axial end wall;
the inner axial end wall and the outer axial end wall are coupled to one another by an inner annular wall and an outer annular wall;
the inlet port is positioned on the outer axial end wall; and
the first outlet passage is positioned on the outer annular wall and the second outlet passage is positioned on the inner axial end wall.

17. A method of protecting a seal mounted on a shaft from airborne contaminates, the method comprising:
rotating a contaminate separator positioned adjacent the seal such that air is drawn into an internal cavity of the contaminate separator;
separating the air in the internal cavity into a higher-contaminated air flow and a lower-contaminated air flow;
discharging the higher-contaminated air flow from the internal cavity to the atmosphere; and
directing the lower-contaminated air flow from the internal cavity to the seal.

18. The method of claim 17, wherein directing the lower-contaminated air flow to the seal induces a positive pressure around the seal and inhibits ingress of contaminates from the atmosphere.

19. The method of claim 17, wherein rotating the shaft causes the rotating of the contaminate separator and produces centrifugal forces that separate the air into the higher-contaminated air flow and the lower-contaminated air flow.

20. The method of claim 17, wherein:
the lower-contaminated air flow accumulates at an inner annular wall of the separator; and
the higher-contaminated air flow accumulates at an outer annular wall of the separator.

21. A method of creating a computer-readable three-dimensional model suitable for use in manufacturing the contaminate separator of claim 1, the method comprising:
inputting data representing the contaminate separator to a computer; and
using the data to represent the contaminate separator as a three-dimensional model, the three dimensional model being suitable for use in manufacturing the contaminate separator.

22. The method of claim 21, wherein the inputting of data includes one or more of using a contact-type 3D scanner to contact the contaminate separator, using a non-contact 3D scanner to project energy onto the contaminate separator and receive reflected energy, and generating a virtual three-dimensional model of the contaminate separator using computer-aided design (CAD) software.

23. A computer-readable three-dimensional model suitable for use in manufacturing the contaminate separator of claim 1.

24. A computer-readable storage medium having data stored thereon representing a three-dimensional model suitable for use in manufacturing the contaminate separator of claim 1.

25. A method for manufacturing the contaminate separator of claim 1, the method comprising the steps of:
providing a computer-readable three-dimensional model of the contaminate separator, the three-dimensional model being configured to be converted into a plurality of slices that each define a cross-sectional layer of the contaminate separator; and
successively forming each layer of the contaminate separator by additive manufacturing.
